(19) United States
(12) Patent Application Publication
(10) Pub. No.: US 2019/0390830 A1
(43) Pub. Date: Dec. 26, 2019

(54) Vehicle Luminaire and Vehicle Lamp Device

(71) Applicant: Toshiba Lighting & Technology Corporation, Yokosuka-shi (JP)

(72) Inventors: Toshihiro Hatanaka, Yokosuka-shi (JP); Ryuji Tsuchiya, Yokosuka-shi (JP); Kiyokazu Hino, Yokosuka-shi (JP)

(73) Assignee: Toshiba Lighting & Technology Corporation, Yokosuka-shi (JP)

(21) Appl. No.: 16/266,641

(22) Filed: Feb. 4, 2019

(30) Foreign Application Priority Data
Jun. 22, 2018 (JP) 2018-118898

(51) Int. Cl. F21S 41/141; F21V 19/00; F21V 29/74

(52) U.S. Cl. CPC F21S 41/141; F21V 29/74; F21V 19/004

(57) ABSTRACT

A vehicle luminaire includes: a base having a first recess; at least one thermal radiation fin provided on a side of the base opposite to a side where the first recess is provided; a light-emitting module including a board having a plurality of coupling pads and at least one light-emitting element electrically connected to the coupling pads; a frame-shaped member surrounding the light-emitting element; a holder that is provided in the base, has one end connected to the frame-shaped member and has the other end provided with a second recess; a plurality of first terminals held by the frame-shaped member and having an end protruding inside the frame-shaped member and coming into contact with the coupling pad; and a plurality of second terminals that are held by the holder, have an end exposed to the inside of the second recess, and are electrically connected to the first terminals.

### CROSS-REFERENCE TO RELATED APPLICATION

This application is based upon and claims the benefit of priority from Japanese Patent Application No. 2018-118898, filed on Jun. 22, 2018, the entire contents of which are incorporated herein by reference.

### FIELD

Embodiments described herein relate generally to a vehicle luminaire and a vehicle lamp device.

### BACKGROUND

There is known a vehicle luminaire having a socket and a light-emitting module provided in one end side of the socket and provided with a light-emitting diode (LED).

Heat generated in the light-emitting module is discharged to the outside mainly through the socket. For this reason, the socket has a thermal radiation fin.

Here, if a type, a use purpose, or the like of the vehicle luminaire is changed, a specification, number, arrangement, or the like of the light-emitting diodes, resistances, or the like provided in the light emitting module are changed. Since the light-emitting diode, the resistance, or the like is a heat radiation source, if the specification, number, arrangement, or the like of such elements are changed, a heat radiation amount, a thermal distribution, or the like may be changed. For this reason, the light-emitting module is designed depending on the type or use purpose of the vehicle luminaire, and the socket is designed depending on the designed light-emitting module. That is, a set of the light-emitting module and the socket is manufactured for each type or each use purpose of the vehicle luminaire.

However, in this case, since a plurality of types of light-emitting modifies and sockets are necessary, a manufacturing process, inventory management, or the like becomes complicated. This may degrade productivity or increase a manufacturing cost.

In this regard, it is demanded to develop a technology capable of facilitating communalization of the elements.

### DESCRIPTION OF THE DRAWINGS

FIG. 1 is a schematic perspective view illustrating a vehicle luminaire according to an embodiment;

FIG. 2 is a schematic exploded view illustrating the vehicle luminaire;

FIG. 3 is a schematic plan view illustrating the vehicle luminaire;

FIG. 4 is a schematic cross-sectional view taken along a line A-A;

FIG. 5 is a schematic cross-sectional view illustrating a power-supply unit according to another embodiment;

FIGS. 6A and 6B are schematic views illustrating a combination of elements of the vehicle luminaire; and

FIG. 7 is a schematic partial cross-sectional view illustrating a vehicle lamp device.

### DETAILED DESCRIPTION

According to an embodiment, a vehicle luminaire includes: a base having a first recess opened to one face; at least one thermal radiation fin provided on a side of the base opposite to a side where the first recess is provided; a light-emitting module provided inside the first recess and including a board having a plurality of coupling pads and at least one light-emitting element electrically connected to the plurality of coupling pads; a frame-shaped member provided over the light-emitting module to surround the light-emitting element; a holder that is provided in the base, has one end connected to the frame-shaped member, and has another end provided with a second recess; a plurality of first terminals held by the frame-shaped member and having an end protruding inside the frame-shaped member and coming into contact with the coupling pad; and a plurality of second terminals that are held by the holder, have an end exposed to the inside of the second recess, and are electrically connected to the first terminals.

Embodiments will now be described by way of example with reference to the accompanying drawings. Note that like reference numerals denote like elements throughout the drawings, and they will not be described repeatedly.

(Vehicle Luminaire)

A vehicle luminaire 1 according to this embodiment may be provided, for example, in an automobile, a railroad vehicle, or the like. The vehicle luminaire 1 provided in the automobile may include, for example, a front combination light (such as a combination of a daylight running lamp (DRL), a position lamp, and a turn signal lamp), a rear combination light (such as a combination of a stop lamp, a tail lamp, a turn signal lamp, a back lamp, and a fog lamp), or the like. However, the use purpose of the vehicle luminaire 1 is not limited thereto.

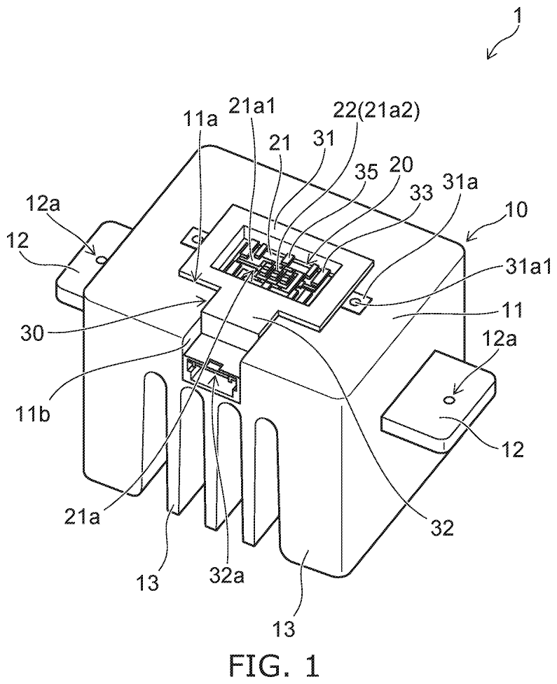

FIG. 1 is a schematic perspective view illustrating the vehicle luminaire 1 according to this embodiment.

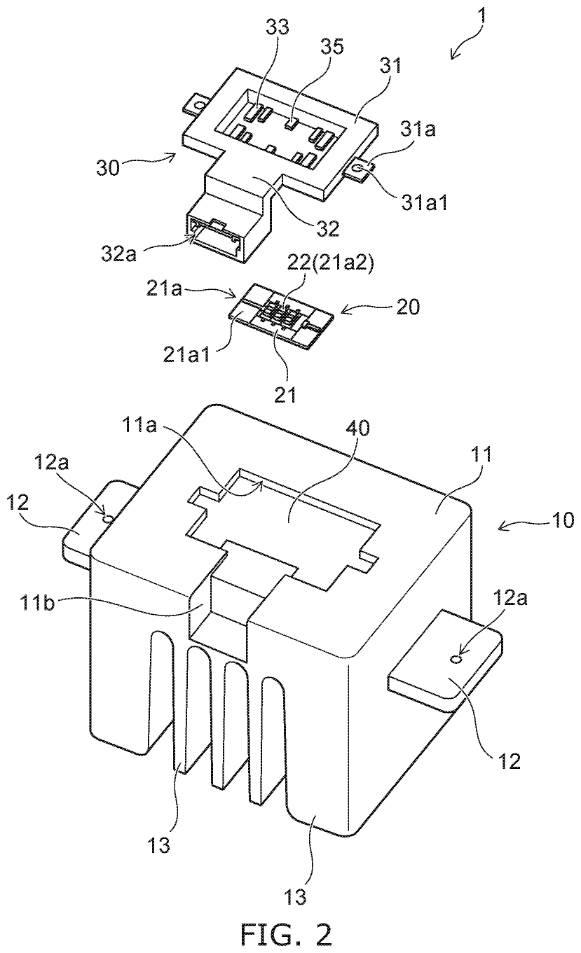

FIG. 2 is a schematic exploded view illustrating the vehicle luminaire 1.

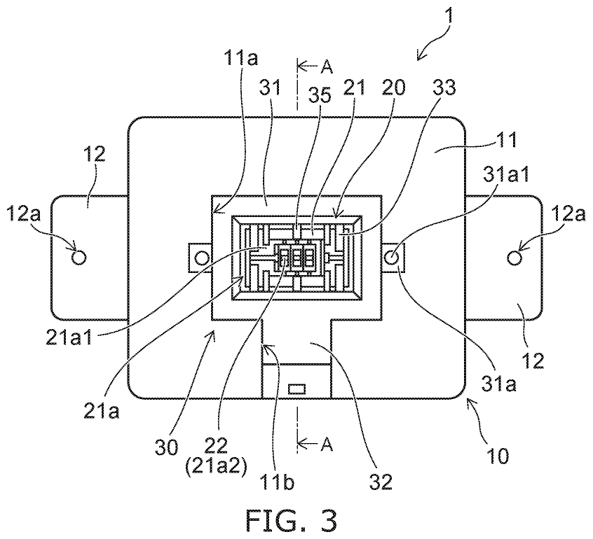

FIG. 3 is a schematic plan view illustrating the vehicle luminaire 1.

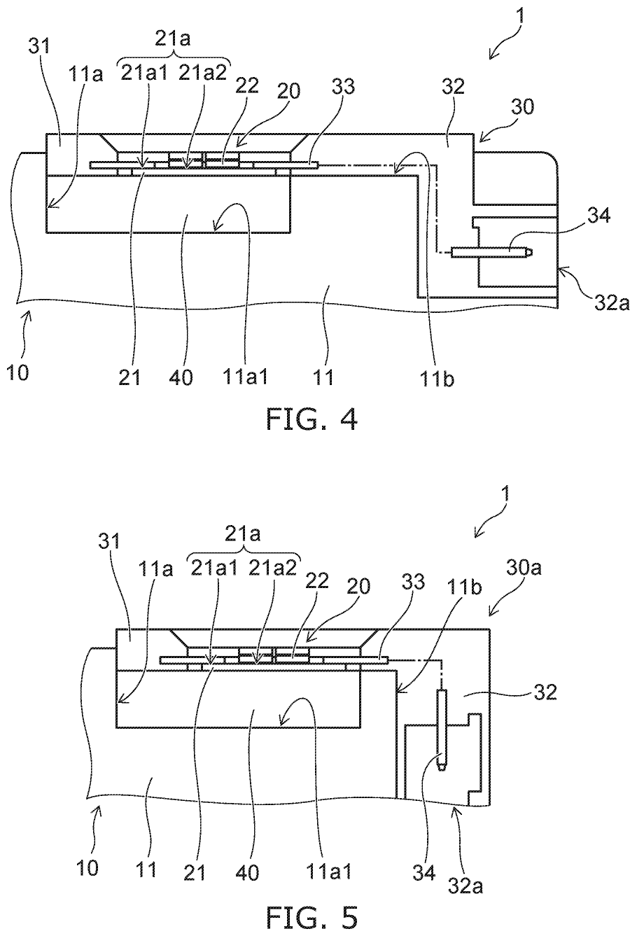

FIG. 4 is a schematic cross-sectional view taken along the line A-A of the vehicle luminaire 1 of FIG. 3.

As illustrated in FIGS. 1 to 4, the vehicle luminaire 1 has a socket 10, a light-emitting module 20, a power-supply unit 30, and a heat-conducting unit 40.

The socket 10 has a base 11, an installation portion 12, and a thermal radiation fin 13.

The base 11 has a plate shape. A planar shape of the base 11 is not particularly limited. The planar shape of the base 11 may include, for example, a square shape such as a rectangular shape, a circular shape, an elliptical shape, or the like. In FIGS. 1 to 3, the base 11 has, for example, a rectangular planar shape.

The base 11 has a recess 11a (corresponding to an example of a first recess) and a recess 11b (corresponding to an example of a third recess) opened to an end face opposite to the thermal radiation fin 13 side. The recess 11a is provided in a center region of the end face of the base 11. One end of the recess lib is connected to the recess 11a. The other end of the recess 11b is opened to a side face of the base 11.

That is, the base 11 has the recess 11a opened to one face. In addition, the base 11 has the recess lib connected to the recess 11a and opened to one face and a side face of the base 11.

At least one installation portion 12 may be provided on a side face of the base 11 or the thermal radiation fin 13. In FIGS. 1 to 3, two installation portions 12 are provided by way of example. The installation portion 12 protrudes outward of the vehicle luminaire 1. The installation portion 12 may have a plate shape. The installation portion 12 is used to install the vehicle luminaire 1 in a casing 101 of the vehicle lamp device 100. For example, a hole 12a may be provided in the installation portion 12, and the vehicle luminaire 1 (socket 10) may be installed in the casing 101 by fastening a fastening member such as a screw inserted into the hole 12a. Note that, the installation portion 12 is not limited to that shown in this example. For example, when the base 11 has a circular planar shape, the installation portion 12 may be used in twist locking. In this case, it is not necessary to provide the hole 12a in the installation portion 12.

The thermal radiation fin 13 is provided on an end face opposite to a side of the base 11 where the light-emitting module 20 is provided. At least one thermal radiation fin 13 may be provided. In FIGS. 1 to 3, five thermal radiation fins 13 are provided by way of example. The plurality of thermal radiation fins 13 may be arranged side by side along a predetermined direction. The thermal radiation fin 13 may have a plate shape.

That is, at least one thermal radiation fin 13 is provided in a side of the base 11 opposite to the side where the recess 11a is provided.

Here, if the vehicle luminaire 1 (light-emitting module 20) is lighted, heat is generated in the light-emitting module 20. The heat generated in the light-emitting module 20 is transferred to the thermal radiation fin 13 mainly via the base 11. The heat transferred to the thermal radiation fin 13 is discharged to the outside from the thermal radiation fin 13.

In this case, if the temperature of the light-emitting element 22 excessively increases due to the heat generated in the light-emitting module 20, a service life of the light-emitting element 22 may be reduced, or it may be difficult to obtain a predetermined amount of light. For this reason, the socket 10 is preferably configured to efficiently radiate the heat generated in the light-emitting module 20, In addition, in the case of the vehicle luminaire 1, the socket 10 is preferably light-weighted. For this reason, considering the heat transferred from the light-emitting module 20 to the outside, the socket 10 is preferably formed of a material having a high heat conductivity. The material having a high heat conductivity includes, for example, metal such as aluminum or an aluminum alloy, high thermal conductivity resin, or the like. The high thermal conductivity resin is obtained by mixing a filler using an inorganic material with resin such as polyethylene terephthalate (PET), polybutylene terephthalate (PBT), or nylon. The filler may include, for example, ceramics such as aluminum oxide, carbon, or the like. By forming the socket 10 using the high thermal conductivity resin, it is possible to efficiently radiate the heat generated in the light-emitting module 20 and achieve a light weight.

In this case, the entire socket 10 may be formed of metal or high thermal conductivity resin. Alternatively, a part of the socket 10 may be formed of metal, and the remaining part may be formed of high thermal conductivity resin.

When the entire socket 10 is formed of the same material, the base 11, the installation portion 12, and the thermal radiation fin 13 may be integrally molded through die casting, injection molding, or the like. When a part of the socket 10 is formed of a different material, the socket 10 may be formed through insert molding or bonding. In this case, if the entire socket 10 is formed of high thermal conductivity resin, it is possible to efficiently radiate the heat generated in the light-emitting module 20 and reduce the weight of the socket 10.

The light-emitting module 20 is provided over the heat-conducting unit 40 inside the recess 11a.

The light-emitting module 20 has a board 21 and a light-emitting element 22.

The board 21 preferably has the same planar shape as that of the recess 11a. The board 21 preferably has a planar dimension slightly smaller than that of the recess 11a. As a result, it is possible to position the socket 10 and the light-emitting module 20 by inserting the board 21 (light-emitting module 20) into the inside of the recess 11a.

The board 21 has a plate shape. A material or structure of the board 21 is not particularly limited. For example, the board 21 may be formed of an inorganic material such as ceramics (for example, aluminum oxide, aluminum nitride, or the like), an organic material such as paper phenol or glass epoxy, or the like. In addition, the board 21 may be formed by coating an insulating material on a surface of a metal plate. Note that, when the surface of the metal plate is coated with an insulating material, the insulating material may contain either an organic material or an inorganic material. When the heat amount radiated from the light-emitting element 22 is large, the board 21 is preferably formed of a material having a high heat conductivity from the viewpoint of heat radiation. The material having a high heat conductivity may include, for example, ceramics such as aluminum oxide or aluminum nitride, high thermal conductivity resin, a metal plate coated with an insulating material, or the like. In addition, the board 21 may have either a single layer structure or a multilayer structure.

A wiring pattern 21a is provided on a surface of the board 21. The wiring pattern 21a has a plurality of coupling pads 21a1 and at least one mount pad 21a2. The wiring pattern 21a may be formed of, for example, a material containing silver as a main component. The wiring pattern 21a may be formed of, for example, silver or a silver alloy. However, the material of the wiring pattern 21a is not limited to the material containing silver as a main component. The wiring pattern 21a may be formed of, for example, a material containing copper as a main component, or the like.

The light-emitting element 22 is electrically connected to the mount pad 21a2. The light-emitting element 22 is mounted to the mount pad 21a2. That is, the light-emitting element 22 is electrically connected to the plurality of coupling pads 21a1. The light-emitting element 22 may include, for example, a light-emitting diode, an organic light-emitting diode, a laser diode, or the like. At least one light-emitting element 22 may be provided. When the plurality of light-emitting elements 22 are provided, the plurality of light-emitting elements 22 may be connected to each other in series.

The type of the light-emitting element 22 is not particularly limited. The light-emitting element 22 may include, for example, a surface-mounted light-emitting element such as a plastic leaded chip carrier (PLCO) type. Note that, in FIGS. 1 to 3, the light-emitting element 22 is the surface-mounted light-emitting element by way of example.

The light-emitting element 22 may include, for example, a light-emitting element having a lead wire, such as a shell type.

The light-emitting element 22 may be embedded in a chip-on-board (COB). When the light-emitting element 22 is embedded in the COB, the chip type light-emitting element 22, a wire that electrically connects the light-emitting element 22 and the wiring pattern 21a, a sealing portion that covers the chip type light-emitting element and the wire, and the like may be provided on the board 21. In this case, the sealing portion may contain phosphor. The phosphor may include, for example, yttrium-aluminum-garnet-based (YAG-based) phosphor. Note that the type of the phosphor is not particular limited to this example. The type of the phosphor may be appropriately changed such that a desired luminescent color can be obtained depending on the use purpose of the vehicle luminaire 1 or the like.

Here, since a forward bias characteristic of the light-emitting element 22 has a variation, a variation occurs in brightness (light flux, luminance, light intensity, or illuminance) of light emitted from the light-emitting element 22 when a constant voltage is applied between an anode terminal and a ground terminal. For this reason, a current value flowing to the light-emitting element 22 is controlled to a predetermined range such that the brightness of light emitted from the light-emitting element 22 is within a predetermined range. For example, it is possible to control the current value flowing to the light-emitting element 22 to a predetermined range by providing a resistance connected in series to the light-emitting element 22 and changing the resistance value of the resistance 23.

The resistance may be, for example, a surface-mounted resistor, a resistor having a lead wire (metal oxide film resistor), a film type resistor formed by a screen print method, or the like. When the resistance is the surface-mounted resistor, the resistor having a lead wire, or the like, a resistance having a suitable resistance value is selected depending on a forward bias characteristic of the light-emitting element 22. When the resistance is a film type resistor, the resistance value can increase by removing a part of the resistance. For example, a part of the resistance can be easily removed by irradiating the resistance with laser light.

In addition, a diode may be provided in order to prevent a reverse voltage from being applied to the light-emitting element 22 and prevent a reverse pulse noise from being applied to the light-emitting element 22. The diode may be connected in series to the light-emitting element 22.

A pull-down resistance may be provided in order to detect disconnection of the light-emitting element 22 or prevent erroneous lighting, or the like. In addition, a coating may be provided to cover the wiring pattern 21a, the film type resistor, and the like. The coating may include, for example, a glass material.

The power-supply unit 30 has a frame 31, a holder 32, a first terminal 33, a second terminal 34, and a holding portion 35.

The frame 31 is provided over the light-emitting module 20. In this case, the frame 31 is preferably provided inside the recess 11a. The frame 31 preferably has the same planar shape as that of the recess 11a. The frame 31 preferably has a planar dimension slight smaller than that of the recess 11a. As a result, it is possible to position the light-emitting module 20 and the power-supply unit 30 (frame 31) by inserting the frame 31 into the inside of the recess 11a.

The frame 31 has a frame shape and is configured to surround the plurality of light-emitting elements 22. The frame 31 is formed of resin having an insulating property. The resin may include, for example, thermoplastic resin such as PBT, polycarbonate (PC), PET, nylon, polypropylene (PP), polyethylene (PE), or polystyrene (PS).

A reflectance to the light emitted from the light-emitting element 22 may be improved by mixing particles such as titanium oxide with the resin. Note that any particle formed of a material having a high reflectance to the light emitted from the light-emitting element 22 may be mixed without limiting to the titanium oxide particle. In addition, the frame 31 may be formed of, for example, white resin.

The inner face of the frame 31 is an inclined surface, which is inclined in a direction away from a center axis of the frame 31 as the distance from the board 21 increases. For this reason, a part of the light emitted from the light-emitting element 22 is reflected on the inner face of the frame 31 and is emitted toward a front face side of the vehicle luminaire 1. That is, the frame 31 may have a function of the reflector and a function of holding the first terminal 33 and the holding portion 35.

An installation portion 31a may be provided on an outer face of the frame 31. At least one installation portion 31a may be provided. In FIGS. 1 to 3, two installation portions 31a are provided by way of example. The installation portion 31a protrudes outward of the frame 31. The installation portion 31a may have a plate shape. The installation portion 31a is used to install the power-supply unit in the socket 10. For example, a hole 31a1 may be provided in the installation portion 31a, and the power-supply unit 30 may be installed in the socket 10 by fastening a fastening member such as a screw inserted into the hole 31a1. Note that the installation portion 31a is not limited to the illustrated example. For example, the installation portion 31a may be pressedly inserted into the hole of the base 11, may be bonded to the base 11, or may be fixed using a rivet or a hook.

The holder 32 is provided over the base 11. In this case, the holder 32 is preferably provided inside the recess 11b. The holder 32 preferably has a planar dimension slightly smaller than that of the recess 11b. As a result, it is possible to allow the holder 32 to be supported by the base 11 by inserting the holder 32 into the inside of the recess lib. For this reason, it is possible to suppress a position of the holder 32 from being deviated or prevent a breakdown of the holder 32 when a connector 105 is inserted into the holder 32.

One end of the holder 32 is connected to the frame 31. The other end of the holder 32 is exposed to the side face of the base 11. A recess 32a (corresponding to an example of a second recess) is provided in the other end of the holder 32. The recess 32a is opened to the other end of the holder 32. The connector 105 having a seal member 105a is inserted into the recess 32a. For this reason, the recess 32a has a cross-sectional shape matching the cross-sectional shape of the connector 105 having the seal member 105a.

The holder 32 may be formed of resin having an insulating property. The holder 32 may be formed of the same material as that of the frame 31 or may be formed of a different material. In addition, the frame 31 and the holder 32 may be formed integrally, for example, through injection molding, two color molding, or the like.

A plurality of first terminals 33 are provided. The plurality of first terminals 33 may have a bar shape. The plurality of first terminals 33 are held by the frame 31. Ends of the plurality of first terminals 33 protruding toward the inside of the frame 31 come into contact with the coupling pad 21a1. The ends of the first terminals 33 protrude from the inner face of the frame 31. The ends of the first terminals 33 are provided to match the coupling pad 21a1. When the power-supply unit 30 is installed in the socket 10, the first terminal 33 makes electric contact with the coupling pad 21a1. In this case, the first terminal 33 abuts on the coupling pad 21a1 by virtue of an elastic force of the first terminal 33. The number or arrangement of the first terminals 33 may be appropriately changed depending on the number of arrangement of the coupling pads 21a1. The first terminal 33 has an electric conductivity. The first terminal 33 may be formed of, for example, metal such as a copper alloy.

A plurality of second terminals 34 are provided. The plurality of second terminals 34 may have a bar shape. The plurality of second terminals 34 are held by the holder 32.

Ends of the second terminals 34 are exposed to the inside of the recess 32a. The connector 105 is fitted to the end of the second terminal 34 exposed to the inside of the recess 32a. The second terminal 34 has an electric conductivity. The second terminal 34 may be formed of, for example, metal such as a copper alloy. In addition, each of the plurality of second terminals 34 makes electric contact with the corresponding first terminal 33. Note that each of the plurality of first terminals 33 may be integrally formed with the corresponding second terminal 34.

At least one holding portion 35 may be provided. The holding portion 35 may have a bar shape or a plate shape. The holding portion 35 is held by the frame 31. An end of the holding portion 35 protruding to the inside of the frame 31 comes into contact with the board 21. An end of the holding portion 35 protrudes from the inner face of the frame 31. The end of the holding portion 35 is provided in a position contactable with the board 21. When the power-supply unit 30 is installed in the socket 10, the holding portion 35 comes into contact with the board 21. In this case, the light-emitting module 20 (board 21) is pressed to the base 11 by virtue of an elastic force of the holding portion 35, and the light-emitting module 20 is held by the socket 10. The number or arrangement of the holding portion 35 may be appropriately determined depending on the arrangement of the coupling pads 21a1. The holding portion 35 may be formed of, for example, metal such as a stainless steel or a copper alloy.

Note that the holding portion 35 is not indispensable and may be omitted if it is not indispensable. When the holding portion 35 is omitted, the light-emitting module 20 is held by the socket 10 by virtue of an elastic force of the plurality of first terminals 33. However, if the holding portion 35 is provided, it is possible to reliably hold the light-emitting module 20. In addition, it is possible to suppress the first terminal 33 from being broken down or prevent a connection failure.

The frame 31, the holder 32, the first terminal 33, the second terminal 34, and the holding portion 35 may be integrally formed through insert molding or the like.

The heat-conducting unit 40 may have a plate shape. The heat-conducting unit 40 is provided inside the recess 11a. The heat-conducting unit 40 may be provided on a bottom face 11a1 of the recess 11a. The heat-conducting unit 40 may be provided between the bottom face 11a1 of the recess 11a and the light-emitting module 20 (board 21). The heat-conducting unit 40 is provided on the bottom face 11a1 of the recess 11a by interposing a bonding layer. That is, the heat-conducting unit 40 is bonded to the bottom face 11a1 of the recess 11a. An adhesive used to bond the heat-conducting unit 40 to the bottom face 11a1 of the recess 11a preferably includes an adhesive having a high heat conductivity. For example, the adhesive may be an adhesive mixed with a filler formed of an inorganic material. The inorganic material preferably includes a material having a high heat conductivity (for example, ceramics such as aluminum oxide or aluminum nitride). The adhesive has a heat conductivity, for example, equal to or higher than 0.5 W/(m·K) and equal to or lower than 10 W/(m·K).

The heat-conducting unit 40 may be buried in the bottom face 11a1 of the recess 11a through insert molding. In addition, the heat-conducting unit 40 may be provided on the bottom face 11a1 of the recess 11a by interposing a heat-conductive grease (heat radiation grease) layer. The type of the heat-conductive grease is not particular limited. For example, the heat-conductive grease may be formed by mixing modified silicon with a filler formed of a high heat conductivity material (for example, ceramics such as aluminum oxide or aluminum nitride). The heat-conductive grease may have a heat conductivity, for example, equal to or higher than 1 W/(m·K) and equal to or lower than 5 W/(m·K). A heat-conductive grease layer may also be provided between the heat-conducting unit 40 and the board 21.

The heat-conducting unit 40 is not indispensable and may be omitted. However, if the heat-conducting unit 40 is provided, it is possible to easily transfer the heat generated in the light-emitting module 20 to the socket 10. The heat-conducting unit 40 is preferably formed of a material having a high heat conductivity. The heat-conducting unit 40 may be formed of, for example, metal such as aluminum, an aluminum alloy, copper, or a copper alloy.

FIG. 5 is a schematic cross-sectional view illustrating a power-supply unit 30a according to another embodiment.

In the case of the power-supply unit 30 described above, an end of the holder 32 where the recess 32a is provided is exposed to the side face of the base 11. In comparison, in the case of the power-supply unit 30a according to this embodiment, an end of the holder 32 of the side where the recess 32a is provided is exposed to the face of the base 11 opposite to the light-emitting module 20 side as illustrated in FIG. 5.

In this case, the base 11 may have a recess lib (corresponding to an example of a third recess) connected to the recess 11a. The recess lib is opened to one side of the base 11 (an end face opposite to the thermal radiation fin 13 side) and a side of the base 11 opposite to the side where the recess 11a is provided.

As described above, an end of the holder 32 of the side where the recess 32a is provided may be exposed to the side face of the base 11 or the side of the base 11 opposite to the light-emitting module 20 side.

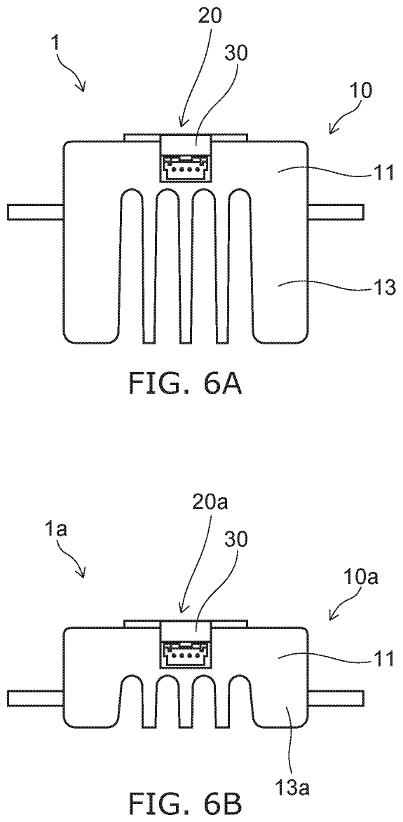

FIGS. 6A and 6B are schematic views illustrating a combination of elements of the vehicle luminaire 1.

In the vehicle luminaire 1, for example, the base 11 having the recesses 11a and 11b is commonalized. The planar shape and the planar dimension of the board 21, and the arrangement of the coupling pad 21a1 are commonalized. The power-supply unit 30 is commonalized.

Meanwhile, the type, specification, number, arrangement, or the like of the light-emitting element 22, the resistance, or the like are appropriately changed depending on the type, use purpose, or the like of the vehicle luminaire 1. In addition, the number, arrangement, size, or the like of the thermal radiation fins 13 are appropriately changed depending on the heat amount generated in the light-emitting module 20, or the like.

Here, if the type, use purpose, or the like of the vehicle luminaire 1 are changed, the specification, number, arrangement, or the like of the light-emitting element, the resistance, or the like provided in the light-emitting module are changed. Since the light-emitting element, the resistance, or the like is a heat radiation source, a heat radiation amount, a thermal distribution, or the like may be changed if such specification, number, arrangement, or the like are changed. For this reason, in general, the light-emitting module is designed depending on the type, use purpose, or the like of the vehicle luminaire, and a dedicated socket is designed depending on the designed light-emitting module. That is, a set of the light-emitting module and the socket is manufactured for each type, use purpose, or the like of the vehicle luminaire.

However, in this case, a plurality of types of light-emitting modules and sockets are necessary. Therefore, a manufacturing process, inventory management, or the like become complicated, or productivity is degraded. Accordingly, a manufacturing cost may increase.

In the vehicle luminaire 1 according to this embodiment, for example, it is possible to easily communalize the base 11, the planar shape and planar dimension of the board 21, the arrangement of the coupling pad 21a1, and the power-supply unit 30.

For this reason, when the specification, number, arrangement, or the like of the light-emitting element 22, the resistance, or the like are changed depending on the type, use purpose, or the like of the vehicle luminaire 1, the vehicle luminaire 1 may be configured by selecting the socket 10 and the light-emitting module 20 having the thermal radiation fin 13 suitable for that and combining the power-supply unit 30 commonalized with these elements.

For example, when a heat radiation amount of the light-emitting module 20 is large, the vehicle luminaire 1 may be configured by combining the socket 10 having the thermal radiation fin 13 having a long length (large surface area), the light-emitting module 20, and the commonalized power-supply unit 30 as illustrated in FIG. 6A.

For example, when the heat radiation amount of the light-emitting module 20 is small, the vehicle luminaire 1a may be configured by combining the socket 10a having the thermal radiation fin 13a having a short length (small surface area), the light-emitting module 20a, and the commonalized power-supply unit 30 as illustrated in FIG. 6B.

Note that there may be a case where the heat radiation amount is not changed much even when the specification, arrangement, or the like of the light-emitting element 22, the resistance, or the like is changed. In this case, it is possible to commonalize the socket 10 and the power-supply unit 30.

That is, in the vehicle luminaire 1 according to this embodiment, it is possible to easily commonalize at least the power-supply unit 30.

Since the base 11 is commonalized, it is possible to facilitate design of the socket 10 or manufacturing of the socket 10.

In the vehicle luminaire 1 according to this embodiment, it is possible to reduce the types of the elements of the vehicle luminaire 1. For this reason, it is possible to simplify the manufacturing process, inventory management, or the like, and to improve productivity. Therefore, the manufacturing cost can be easily reduced.

(Vehicle Lamp Device)

Next, the vehicle lamp device 100 will be described.

Note that, in the following description, it is assumed that the vehicle lamp device 100 is a front combination light provided in an automobile by way of example. However, the vehicle lamp device 100 is not limited to the front combination light provided in an automobile. The vehicle lamp device 100 may be a vehicle lamp device provided in an automobile, a railroad vehicle, or the like.

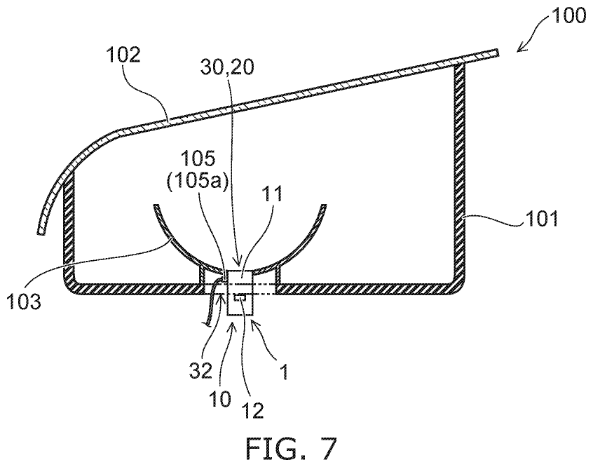

FIG. 7 is a schematic partial cross-sectional view illustrating the vehicle lamp device 100.

As illustrated in FIG. 7, the vehicle lamp device 100 has a vehicle luminaire 1, a casing 101, a cover 102, an optical element unit 103, and a connector 105.

The casing 101 holds the vehicle luminaire 1. The casing 101 has a box shape whose one end side is opened. The casing 101 may be formed of, for example, resin or the like that does not transmit light. A bottom face of the casing 101 is provided with a hole into which the base 11 is inserted.

In order to install the vehicle luminaire 1 in the vehicle lamp device 100, for example, the vehicle luminaire 1 (socket 10) is installed in the casing 101 using a fastening member such as a screw inserted into the hole 12a of the installation portion 12.

The cover 102 is provided to block the opening of the casing 101. The cover 102 may be formed of light transmissive resin or the like. The cover 102 may have a function of a lens or the like.

The light emitted from the vehicle luminaire 1 is incident on the optical element unit 103. The optical element unit 103 performs reflection, diffusion, light guiding, condensation, formation of a predetermined luminous intensity distribution pattern, or the like for the light emitted from the vehicle luminaire 1.

For example, the optical element unit 103 of FIG. 7 is a reflector. In this case, the optical element unit 103 reflects the light emitted from the vehicle luminaire 1 to form a predetermined luminous intensity distribution pattern.

The connector 105 is fitted to a plurality of second terminals 34 exposed to the inside of the recess 32a. A power-supply or the like (not shown) is electrically connected to the connector 105. For this reason, by fitting the connector 105 to ends of a plurality of second terminals 34, the power-supply or the like (not shown) and the light-emitting element 22 are electrically connected to each other.

The connector 105 has a stepped portion. In addition, the seal member 105a is installed in the stepped portion. The seal member 105a is provided to prevent water from intruding to the inside of the recess 32a. When the connector 105 having the seal member 105a is inserted into the recess 32a, the recess 32a is water-tightly sealed.

The seal member 105a may have an annular shape. The seal member 105a may be formed of an elastic material such as rubber or silicone resin. The connector 105 may be bonded to an element of the socket 10 side, for example, using an adhesive or the like.

In addition, a cover, a seal member, or the like that blocks a gap between the inner wall of the hole provided on the bottom face of the casing 101 and the base 11 may be appropriately provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A vehicle luminaire comprising:
a base having a first recess opened to one face;
at least one thermal radiation fin provided on a side of the base opposite to a side where the first recess is provided;
a light-emitting module provided inside the first recess and including a board having a plurality of coupling pads and at least one light-emitting element electrically connected to the plurality of coupling pads;
a frame-shaped member provided over the light-emitting module to surround the light-emitting element;
a holder that is provided in the base, has one end connected to the frame-shaped member, and has another end provided with a second recess;
a plurality of first terminals held by the frame-shaped member and having an end protruding inside the frame-shaped member and coming into contact with the coupling pad; and
a plurality of second terminals that are held by the holder, have an end exposed to the inside of the second recess, and are electrically connected to the first terminals.

2. The luminaire according to claim 1, wherein the frame-shaped member is provided inside the first recess.

3. The luminaire according to claim 1, wherein the base further has a third recess connected to the first recess and opened to the one face and a side face of the base, and
the holder is provided inside the third recess.

4. The luminaire according to claim 1, wherein the base further has a third recess connected to the first recess and opened to the one face of the base and a side opposite to the side where the first recess is provided, and
the holder is provided inside the third recess.

5. The luminaire according to claim 1, further comprising at least one holding portion held by the frame-shaped member such that an end protruding inward of the frame-shaped member comes into contact with the board.

6. The luminaire according to claim 1, wherein each of the plurality of first terminals is formed integrally with the corresponding second terminal.

7. The luminaire according to claim 1, wherein an inner face of the frame-shaped member is inclined in a direction away from a center axis of the frame-shaped member as a distance from the board increases.

8. The luminaire according to claim 1, wherein an outer face of the frame-shaped member is provided with at least one installation portion.

9. The luminaire according to claim 1, wherein the other end of the holder is exposed to the side face of the base, and
the second recess is opened to the other end.

10. The luminaire according to claim 1, wherein the frame-shaped member and the holder are integrally formed.

11. The luminaire according to claim 1, wherein each of the plurality of first terminals comes into contact with the corresponding coupling pad by virtue of an elastic force.

12. The luminaire according to claim 5, wherein an end of the holding portion protrudes from the inner face of the frame-shaped member.

13. The luminaire according to claim 5, wherein the board is pressed to the base by virtue of an elastic force of the holding portion as an end of the holding portion comes into contact with the board.

14. The luminaire according to claim 5, wherein the frame-shaped member, the holder, the first terminal, the second terminal, and the holding portion are integrally formed through insert molding.

15. The luminaire according to claim 1, further comprising a heat-conducting unit provided between a bottom face of the first recess and the board.

16. The luminaire according to claim 15, wherein the heat-conducting unit has a plate shape and is bonded to the bottom face of the first recess or is buried on the bottom face of the first recess through insert molding.

17. The luminaire according to claim 1, wherein the base and the thermal radiation fin are formed of high thermal conductivity resin.

18. The luminaire according to claim 1, wherein the frame-shaped member and the holder are formed of resin having an insulating property.

19. The luminaire according to claim 1, wherein the plurality of first terminals and the plurality of second terminals have an electrical conductivity.

20. A vehicle lamp device comprising:
the vehicle luminaire according to claim 1; and
a casing in which the vehicle luminaire is installed.
